(19) United States
(12) Patent Application Publication
(10) Pub. No.: US 2019/0351598 A1
(43) Pub. Date: Nov. 21, 2019

(54) Cooling System Of Injection Mold

(71) Applicant: Tyco Electronics (Shanghai) Co. Ltd., Shanghai (CN)

(72) Inventors: Zhongxi Huang, Shanghai (CN); Jiankun Zhou, Shanghai (CN)

(73) Assignee: Tyco Electronics (Shanghai) Co. Ltd., Shanghai (CN)

(21) Appl. No.: 16/407,877

(22) Filed: May 9, 2019

(30) Foreign Application Priority Data
May 15, 2018 (CN) 201810462498.1

(51) Int. Cl. B29C 45/73

(52) U.S. Cl. CPC B29C 45/7312; B29C 45/7337

(57) ABSTRACT

A cooling system of an injection mold comprises an air cooling pathway formed in a mold core and having an inlet and an outlet, a vortex tube having a cold air output port, a hot air output port, and a compressed air input port, and a compressed air supply device in communication with the compressed air input port and configured to supply a compressed air to the vortex tube. The vortex tube separates the compressed air into a cold air with a temperature lower than that of the compressed air and a hot air with a temperature higher than that of the compressed air. The cold air is output from the cold air output port. The hot air is output from the hot air output port. The cold air output port communicates with the inlet and supplies the cold air into the air cooling pathway to cool the mold core.

### CROSS-REFERENCE TO RELATED APPLICATION

This application claims the benefit of the filing date under 35 U.S.C. § 119(a)-(d) of Chinese Patent Application No. 201810462498.1, filed on May 15, 2018.

### FIELD OF THE INVENTION

The present invention relates to an injection mold and, more particularly, to a cooling system of an injection mold.

### BACKGROUND

A connector generally includes a contact and a plastic housing. The plastic housing is usually formed by injection molding. An injection molding cycle to form the plastic housing greatly influences the production efficiency of the connector; the cooling time often accounts for the majority of the whole injection molding cycle. Therefore, effectively reducing the cooling time is critical to reducing a duration of the injection molding cycle while ensuring product quality and production stability.

Due to the limitations of a structure of an injection mold and a shape of a product to be molded, a water cooling pathway in the injection mold cannot cool some parts of the injection mold, such as protrusion parts and thick edge parts, which adversely affects the product quality and the injection molding cycle of the product.

An injection mold having a water cooling pathway formed by 3D printing may solve the problem of non-uniform cooling of some complex products, however, an inner wall of the 3D printed water cooling pathway is very rough. Therefore, in practical use, the 3D printed water cooling pathway is easily corroded, clogged, and damaged. In addition, the 3D printed water cooling pathway has a smaller diameter, and the scaling produced in the use of cooling water will further clog the water cooling pathway. Further, in order to achieve high cooling efficiency, high circulating water pressure is required, which makes the water cooling pathway more easily blocked due to corrosion. In a connector housing having a very complex shape and a very small size, the 3D printed water cooling pathway is usually a closed-circuit circulation system, and still cannot reach some hot spots.

### SUMMARY

A cooling system of an injection mold comprises an air cooling pathway formed in a mold core and having an inlet and an outlet, a vortex tube having a cold air output port, a hot air output port, and a compressed air input port, and a compressed air supply device in communication with the compressed air input port and configured to supply a compressed air to the vortex tube. The vortex tube separates the compressed air into a cold air with a temperature lower than that of the compressed air and a hot air with a temperature higher than that of the compressed air. The cold air is output from the cold air output port. The hot air is output from the hot air output port. The cold air output port communicates with the inlet and supplies the cold air into the air cooling pathway to cool the mold core.

### BRIEF DESCRIPTION OF THE DRAWINGS

The invention will now be described by way of example with reference to the accompanying Figures, of which:

FIG. 1 is a sectional side view of a vortex tube according to an embodiment;

FIG. 2 is a perspective view of an air cooling pathway in a mold core of an injection mold according to an embodiment;

FIG. 3 is a perspective view of an air cooling pathway in a mold core of an injection mold according to another embodiment; and

FIG. 4 is a perspective view of an air cooling pathway in a mold core of an injection mold according to another embodiment.

### DETAILED DESCRIPTION OF THE EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

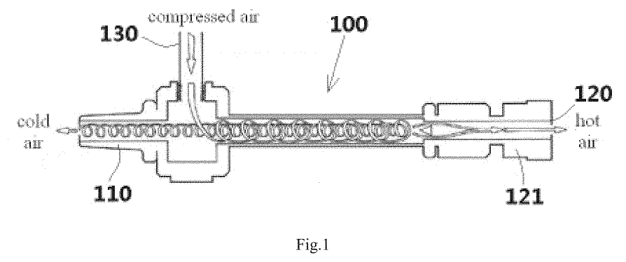

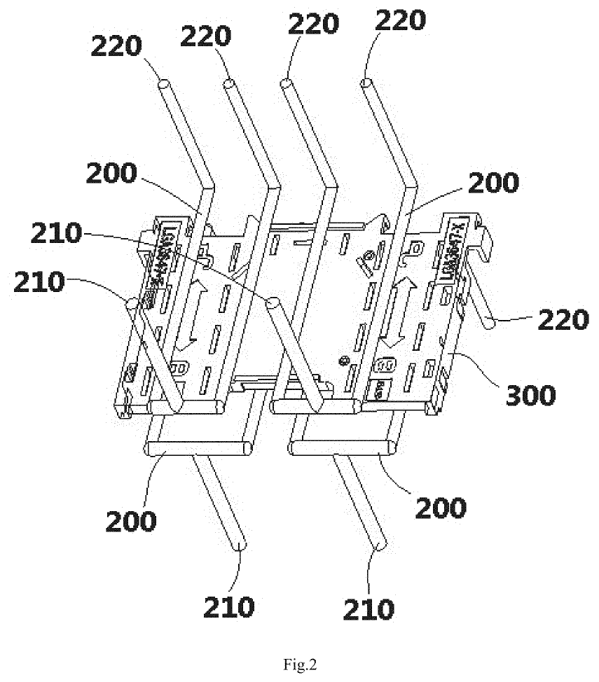

A cooling system of an injection mold according to an embodiment, as shown in FIGS. 1 and 2, comprises a vortex tube 100, an air cooling pathway 200, and a compressed air supply device (not shown). The air cooling pathway 200 is formed in a mold core of the injection mold, as shown in FIG. 2, and has at least one inlet 210 and at least one outlet 220. The vortex tube 100, as shown in FIG. 1, has a cold air output port 110, a hot air output port 120 and a compressed air input port 130. The compressed air supply device communicates with the compressed air input port 130 of the vortex tube 100 and is configured to supply compressed air to the vortex tube 100. The compressed air supply device comprises an air compressor adapted to produce compressed air or an air tank suitable for storing compressed air.

As shown in FIG. 1, the vortex tube 100 is adapted to separate the compressed air input from the compressed air input port 130 into a cold air with a temperature lower than that of the compressed air and a hot air with a temperature higher than that of the compressed air. The cold air is output from the cold air output port 110, the hot air is output from the hot air output port 120. The cold air output port 110 of the vortex tube 100 communicates with the inlet 210 of the air cooling pathway 200, so as to supply the cold air into the air cooling pathway 200 to cool the mold core. The vortex tube 100 has a control valve 121 mounted on the hot air output port 120. The control valve 121 is configured to adjust both the temperature of the cold air and the temperature of the hot air as well as both a flow rate of the cold air and a flow rate of the hot air.

The air cooling pathway 200, as shown in FIG. 2, has a plurality of inlets 210 and a plurality of outlets 220. The plurality of inlets 210 of the air cooling pathway 200 are connected to the cold air output port 110 of the vortex tube 100 via a single multiport joint.

The mold core of the injection mold comprises a male mold core and a female mold core matched with the male mold core. A forming cavity suitable for forming a workpiece 300, as shown in FIG. 2, is defined between the male mold core and the female mold core. One or more air cooling pathways 200 are formed in each of the male mold core and the female mold core, and each air cooling pathway 200 has one or more inlets 210 and one or more outlets 220. The inlets 210 of all air cooling pathways 200 of both the male mold core and the female mold core, as shown in FIG. 2, are connected to the cold air output port 110 of the vortex tube 100 via a single multiport joint.

After flowing through the air cooling pathway 200, the cold air is discharged directly from the outlets 220 of the air cooling pathway 200, shown in FIG. 2, into the atmosphere. In an embodiment, a silencer is installed on the outlet 220 of the air cooling pathway 200 to suppress or eliminate noise when the cold air is discharged from the outlet 220 of the air cooling pathway 200.

In an embodiment, the temperature of the cold air generated by the vortex tube 100, shown in FIG. 1, is below −30° C., and the temperature of the hot air generated by the vortex tube 100 is above 100° C. In another embodiment, the temperature of the cold air generated by the vortex tube 100 is below −40° C., and the temperature of the hot air generated by the vortex tube 100 is above 110° C.

As shown in FIG. 2, in an embodiment, each mold core is formed with two air cooling pathways 200, and each air cooling pathway 200 has one inlet 210 and two outlets 220. In an embodiment, the air cooling pathway 200 is formed by mechanical machining. Since it is difficult to machine curved channels by mechanical machining, only straight channels are machined in this case. As shown in FIG. 2, each air cooling pathway 200 comprises a plurality of straight channels connected to each other so as to form the air cooling pathway 200. In other embodiments, the air cooling pathway 200 may be formed by 3D printing, and the 3D printed air cooling pathway 200 may comprise a plurality of curved channels.

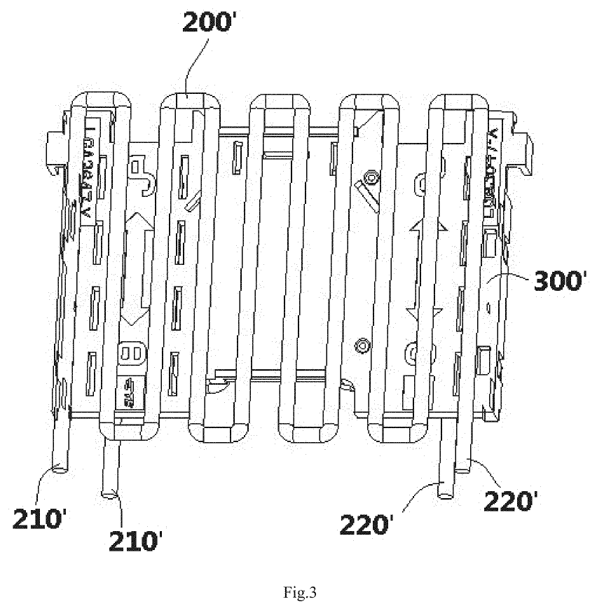

An air cooling pathway 200′ in a mold core of an injection mold according to another embodiment is shown in FIG. 3. The air cooling pathway 200′ is formed by 3D printing, and the air cooling pathway 200′ comprises a plurality of curved channels. In the embodiment shown in FIG. 3, each mold core is formed with one air cooling pathway 200′. Each air cooling pathway 200′ has one inlet 210′ and one outlet 220′.

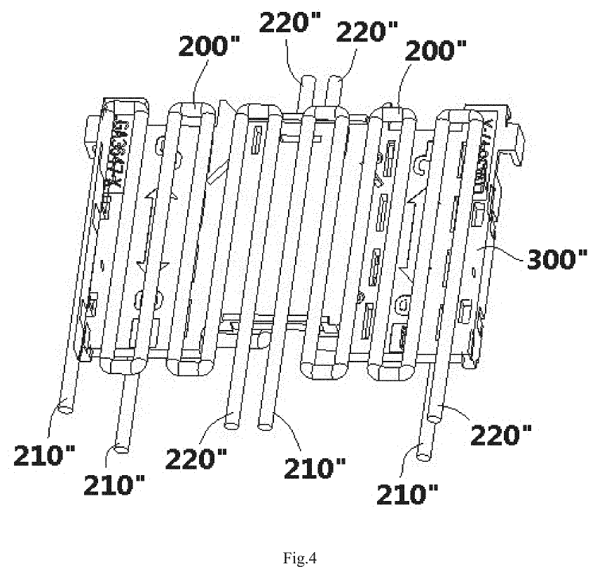

An air cooling pathway 200″ in a mold core of an injection mold according to another embodiment is shown in FIG. 4. The air cooling pathway 200″ is formed by 3D printing, and the air cooling pathway 200″ comprises a plurality of curved channels. In the embodiment shown in FIG. 4, each mold core is formed with two air cooling pathways 200″. Each air cooling pathway 200″ has one inlet 210″ and one outlet 220″.

As shown in FIGS. 2-4, in some embodiments, a structure of the air cooling pathway 200, 200′, 200″ is configured to adapt with a structure of the workpiece 300, 300′, 300″ to be molded. That is, the structure of the air cooling pathway 200, 200′, 200″ depends on the structure of the workpiece 300, 300′, 300″ to be molded.

In the cooling system of the injection mold according to the embodiments of the disclosure, the air cooling avoids the need for a closed-loop cooling pathway with the air cooling pathway 200, and corrosion and leakage are avoided. The cold air does not cause corrosion and blockage of the air cooling pathway 200, and the cooling position is closer to the surface of the mold core, which improves the cooling efficiency. The air cooling pathway 200 is simple and flexible in design. The diameter of the air cooling pathway 200 in the mold core is not limited and may be much smaller than that of a water cooling pathway. The vortex tube 100 permits easy control of the temperature and flow rate of the generated cold air, reducing cost. Furthermore, the cold air is directly discharged into the atmosphere without any pollution to the atmosphere.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle. Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A cooling system of an injection mold, comprising:
an air cooling pathway formed in a mold core of the injection mold and having an inlet and an outlet;
a vortex tube having a cold air output port, a hot air output port, and a compressed air input port; and
a compressed air supply device in communication with the compressed air input port and configured to supply a compressed air to the vortex tube, the vortex tube is adapted to separate the compressed air into a cold air with a temperature lower than that of the compressed air and a hot air with a temperature higher than that of the compressed air, the cold air is output from the cold air output port, the hot air is output from the hot air output port, the cold air output port is in communication with the inlet and supplies the cold air into the air cooling pathway to cool the mold core.

2. The cooling system of claim 1, wherein the vortex tube has a control valve mounted on the hot air output port.

3. The cooling system of claim 2, wherein the control valve is configured to adjust both the temperature of the cold air and the temperature of the hot air as well as both a flow rate of the cold air and a flow rate of the hot air.

4. The cooling system of claim 1, wherein the air cooling pathway has a plurality of inlets and a plurality of outlets, the plurality of inlets are connected to the cold air output port by a single multiport joint.

5. The cooling system of claim 1, wherein the mold core of the injection mold has a male mold core and a female mold core matched with the male mold core, a forming cavity suitable for forming a workpiece is defined between the male mold core and the female mold core.

6. The cooling system of claim 5, wherein the air cooling pathway is formed in each of the male mold core and the female mold core.

7. The cooling system of claim 1, wherein, after flowing through the air cooling pathway, the cold air is discharged directly from the outlet into an atmosphere.

8. The cooling system of claim 7, wherein a silencer is installed on the outlet to suppress or eliminate noise when the cold air is discharged from the outlet.

9. The cooling system of claim 6, wherein the air cooling pathway includes a plurality of straight channels.

10. The cooling system of claim 6, wherein the air cooling pathway includes a plurality of curved channels.

11. The cooling system of claim 1, wherein the compressed air supply device includes an air compressor adapted to produce the compressed air or an air tank suitable for storing the compressed air.

12. The cooling system of claim 1, wherein the temperature of the cold air generated by the vortex tube is below −30° C. and the temperature of the hot air generated by the vortex tube is above 100° C.

13. The cooling system of claim 12, wherein the temperature of the cold air generated by the vortex tube is below −40° C. and the temperature of the hot air generated by the vortex tube is above 110° C.

14. The cooling system of claim 1, wherein a structure of the air cooling pathway is configured to adapt with a structure of a workpiece to be molded.
